(19) United States
(12) Patent Application Publication
(10) Pub. No.: US 2026/0066580 A1
(43) Pub. Date: Mar. 5, 2026

(54) ELECTRICAL CONNECTOR AND ELECTRICAL CONNECTOR ASSEMBLY

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: YANG-TSUN HSU, New Taipei (TW); Jerry Wu, Irvine, CA (US); Jun Chen, Kunshan (CN); Xiao Fan, Huaian (CN)

(21) Appl. No.: 19/310,071

(22) Filed: Aug. 26, 2025

(30) Foreign Application Priority Data
Aug. 27, 2024 (CN) 202411182306.3

(51) Int. Cl. H01R 13/627; H01R 12/70; H01R 12/71; H01R 12/75; H01R 13/10; H01R 13/629

(52) U.S. Cl. CPC H01R 13/6272; H01R 12/7082; H01R 12/716; H01R 12/75; H01R 13/10; H01R 13/629

(57) ABSTRACT

An electrical connector includes: a terminal; a housing including: a top portion and a bottom portion; a cavity receiving the terminal, the cavity being in fluid communication with an opening of the bottom portion for entry of a mating terminal; and a latch accommodating channel in communication with the cavity; and a latch movably received in the latch accommodating channel; wherein the latch comprises a release portion exposed by the housing, a first arm opposite to the release portion, and a second arm and a third arm connecting the release portion and the first arm, the release portion, the first arm, the second arm, and the third arm form an enclosing space surrounding the mating terminal, and at least one of the first arm, the second arm, and the third arm has a first protrusion protruding into the enclosing space to lock the mating terminal.

### BACKGROUND OF THE INVENTION

### Field of the Invention

The present invention generally relates to an electrical connector and electrical connector assembly for transmitting large currents.

### Description of Related Arts

In large current transmission application scenarios, stable current transmission is crucial, and any loose connection may cause unstable operation or damage to the equipment. To ensure the stability and safety of power transmission, it is necessary to design a locking mechanism on the connector to prevent accidents or disengagement, ensure safety and connection stability during high current transmission, and ensure the continuity of current transmission and the normal operation of the equipment.

U.S. Pat. No. 11,670,893 discloses a socket connector including a housing having a pin access opening through a bottom open to a cavity configured to receive a pin. The socket connector includes a socket in the cavity electrically connected to a pin. The socket connector includes a latch movably received in a latch pocket to engage the pin to secure the socket connector to the pin. The latch includes a latch release accessible exterior of the housing to release the latch. The latch release moves the latch between a latched position and a clearance position. A latching rib of the latch engages the pin in the latched position and is released from the pin in the clearance position to allow uncoupling of the socket connector from the pin. However, the latching rib that engages with the pin can only be set on the latch, which lacks flexibility, and the latching rib has a relatively low engagement strength with the pin, and the stability is relatively insufficient. Therefore, an improved electrical connector is desired.

### SUMMARY OF THE INVENTION

The main object of the present invention is to provide an improved electrical connector and electrical connector assembly, wherein the electrical connector can achieve a more reliable and stable connection with its mating connector.

To achieve the above-mentioned object, an electrical connector comprises: a cable extending along a first direction; a terminal connected with the cable; a housing comprising: a top portion, a bottom portion, and a first side wall and a second side wall between the top portion and the bottom portion; a cavity receiving the terminal and extending along a second direction perpendicular to the first direction, the cavity being in fluid communication with an opening of the bottom portion for entry of a mating terminal; and a latch accommodating channel in communication with the cavity; and a latch movably received in the latch accommodating channel and configured to engage the mating terminal in a locked position and to release the mating terminal in an unlocked position; wherein the latch comprises a release portion exposed by the housing, a first arm opposite to the release portion, and a second arm and a third arm connecting the release portion and the first arm, the release portion, the first arm, the second arm, and the third arm form an enclosing space surrounding the mating terminal, and at least one of the first arm, the second arm, and the third arm has a first protrusion protruding into the enclosing space to lock the mating terminal.

To achieve the above-mentioned object, an electrical connector comprises: a cable extending along a first direction; a first terminal and a second terminal connected with the cable; a housing comprising: a top portion, a bottom portion, and a first side wall and a second side wall between the top portion and the bottom portion; a first cavity and a second cavity respectively accommodating the first terminal and the second terminal and extending along a second direction perpendicular to the first direction, the bottom portion comprising a pair of openings in communication with the first cavity and the second cavity for a pair of mating terminals to enter the first cavity and the second cavity through the pair of the openings to be electrically connected to the first contact terminal and the second contact terminal; and a latch accommodating channel in communication with the first cavity and the second cavity; and a latch movably received in the latch accommodating channel and configured to engage the mating terminals in a locked position and to release the mating terminals in an unlocked position; wherein the latch comprises a first latch engaging one of the pair of mating terminals and a second latch engaging the other of the pair of mating terminals, each of the first latch and the second latch comprises a release portion exposed by the housing, a first arm opposite to the release portion, and a second arm and a third arm connecting the release portion and the first arm, the release portion, the first arm, the second arm, and the third arm form an enclosing space surrounding the mating terminal and allowing the mating terminal to extend out, and at least one of the first arm, the second arm, and the third arm is provided with a first protrusion protruding into the enclosing space to lock the mating terminal.

To achieve the above-mentioned object, an electrical connector assembly comprises: an electrical connector having a first mating surface and a second 18. An electrical connector assembly comprises: a board-end connector comprising a first mating terminal, a second mating terminal, and a substrate holding the first mating terminal and the second mating terminal; and a cable-end connector mating with the board-end connector, comprising: a cable extending along a first direction; a first terminal and a second terminal connected with the cable; a housing comprising: a top portion, a bottom portion, and a first side wall and a second side wall between the top portion and the bottom portion; a first cavity and a second cavity respectively accommodating the first terminal and the second terminal and extending along a second direction perpendicular to the first direction, the bottom comprising a pair of openings in communication with the first cavity and the second cavity, the first mating terminal and the second mating terminal respectively entering the first cavity and the second cavity through the pair of the openings to be electrically connected to the first contact terminal and the second contact terminal; and a latch accommodating channel in communication with the first cavity and the second cavity; and a latch movably received in the latch accommodating channel and configured to engage the first mating terminal and the second mating terminal in a locked position to lock the cable-end connector with the board-end connector, and to release the first mating terminal and the second mating terminal in an unlocked position to unlock the cable-end connector from the board-end connector; wherein the latch comprises a first latch engaging the first mating terminal and a second latch engaging the second mating terminal, each of the first latch and the second latch comprises a release portion exposed by the housing, a first arm opposite to the release portion, and a second arm and a third arm connecting the release portion and the first arm, the release portion, the first arm, the second arm, and the third arm form an enclosing space surrounding the mating terminal and allowing the mating terminal to extend out, and at least one of the first arm, the second arm, and the third arm is provided with a first protrusion protruding into the enclosing space to lock the mating terminal.

Compared to prior art, the electrical connector of the present invention realize a more reliable and stable connection with its mating connector through the design of the latch structure, thereby ensuring the safety and stability of power transmission.

### BRIEF DESCRIPTION OF DRAWINGS

FIG. 1 is a perspective view of an electrical connector assembly, with a cable-end connector and a board-end connector being in a locked state;

FIG. 2 is a perspective view of the electrical connector assembly shown in FIG. 1, with the cable-end connector and the board-end connector being in an unlocked state;

FIG. 3 is a perspective view of the cable-end connector and the board-end connector;

FIG. 4 is another perspective view of the cable-end connector and the board-end connector;

FIG. 5 is a exploded view of the cable-end connector shown in FIG. 3;

FIG. 6 is another exploded view of the cable-end connector shown in FIG. 5;

FIG. 7 is a cross-sectional view of the electrical connector assembly shown in FIG. 1 taken along line A-A, wherein the latch is in the locked position;

FIG. 8 is a cross-sectional view of the electrical connector assembly shown in FIG. 2 taken along line B-B, wherein the latch is in the unlocked position; and

FIG. 9 is a cross-sectional view of the electrical connector assembly shown in FIG. 1 taken along line C-C.

### DETAILED DESCRIPTION OF DRAWINGS

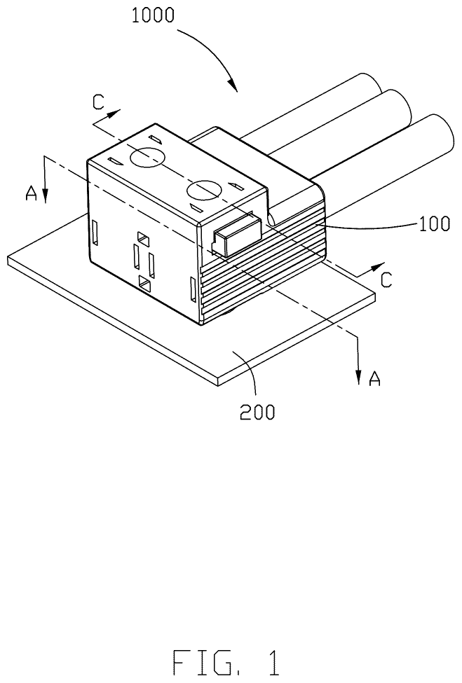

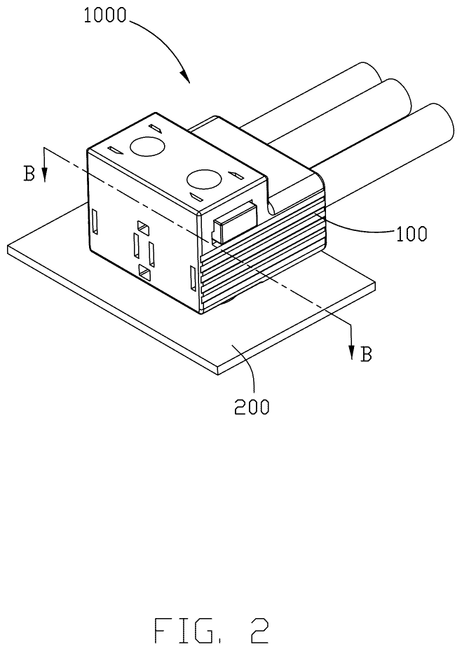

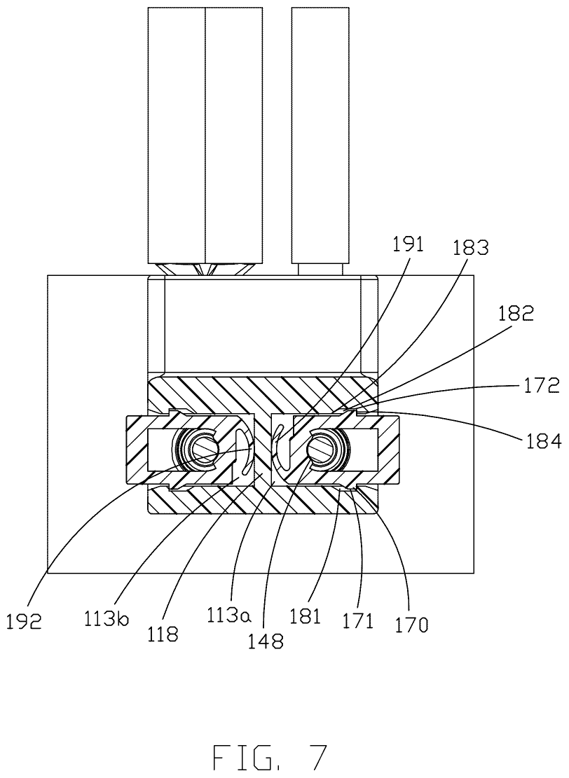

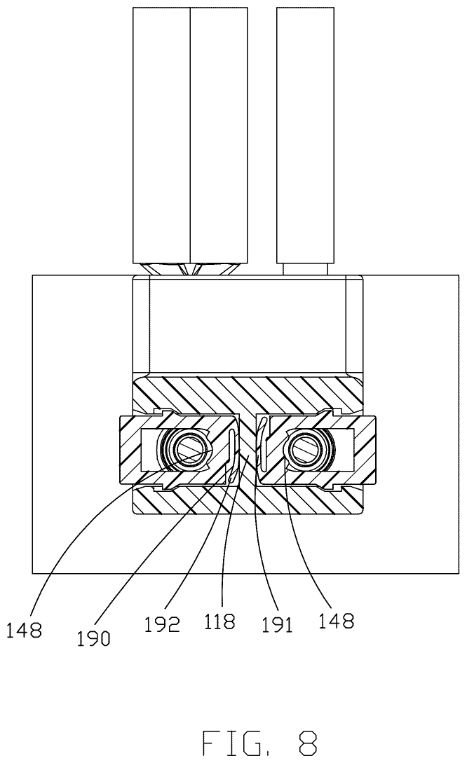

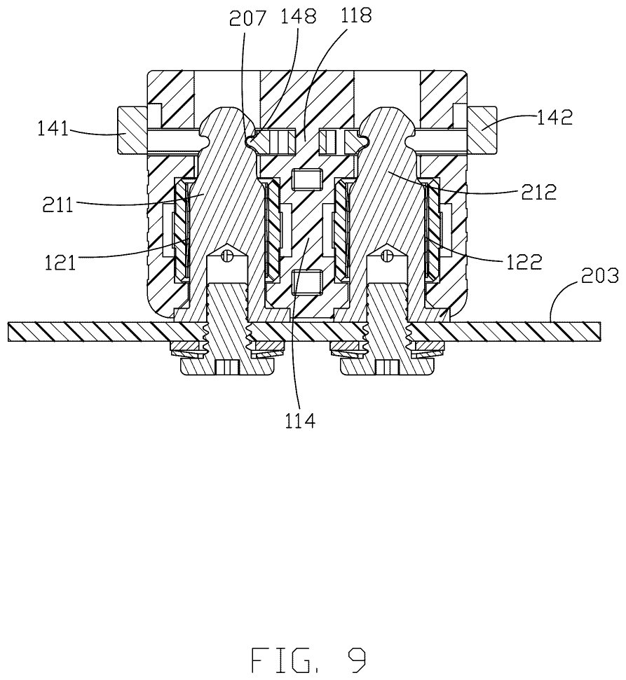

FIGS. 1-9 show an electrical connector assembly 1000 of the present invention. The electrical connector assembly 1000 includes a cable-end connector 100 and a board-end connector 200 mating with the cable connector 100. The cable connector 100 includes a housing 110, a terminal 120 disposed in the housing, a cable 130 extending along a first direction and connected with the terminal 120, and a latch 140 disposed in the housing 110. The cable-end connector 100 is configured to be lockably connected to the board-end connector 200 by the latch 140. As shown in FIGS. 1, 7, and 9, the cable-end connector 100 is lockingly connected to the board end connector 200. In this embodiment, the cable-end connector 100 is provided with a pair of terminals 120, including a first terminal 121 and a second terminal 122. Correspondingly, the board-end connector 200 is provided with a pair of mating terminals 210, including a first mating terminal 211 mating with the first terminal 121 and a second mating terminal 212 mating with the second terminal 122. It can be known that, in other embodiments, the cable-end connector 100 and the board-end connector 200 may have more or fewer terminals and mating terminals. That is, the number of terminals of cable-end connector and the board-end connector may be set according to the specific power or current to be transmitted.

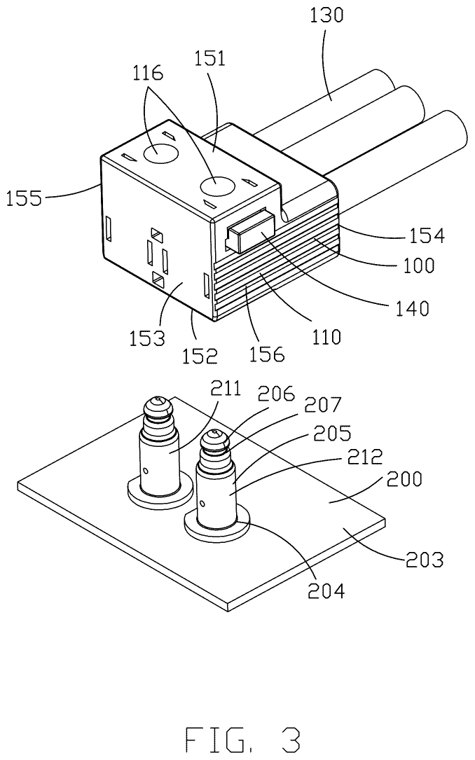

Referring to FIG. 3, the board-end connector 200 includes a substrate 203 holding the first mating terminal 211 and the second mating terminal 212, and the first mating terminal 211 and the second mating terminal may be connected to the substrate 203 by press-fit connection or by screws. In this embodiment, the substrate 203 is a circuit board. In other embodiments, the substrate 203 may also be a bus bar. The first mating terminal 211 and the second mating terminal 212 each include a connecting portion 204 connecting to the substrate 203, a mating end 205 connecting to the terminal 120, and an extending end 206 extending from the mating end 205 in a direction away from the connecting portion 204. The extending end 206 is provided with an inwardly recessed groove 207, and the groove 207 is formed to engage the latch 140 to lock the board-end connector 200 with the cable-end connector 100.

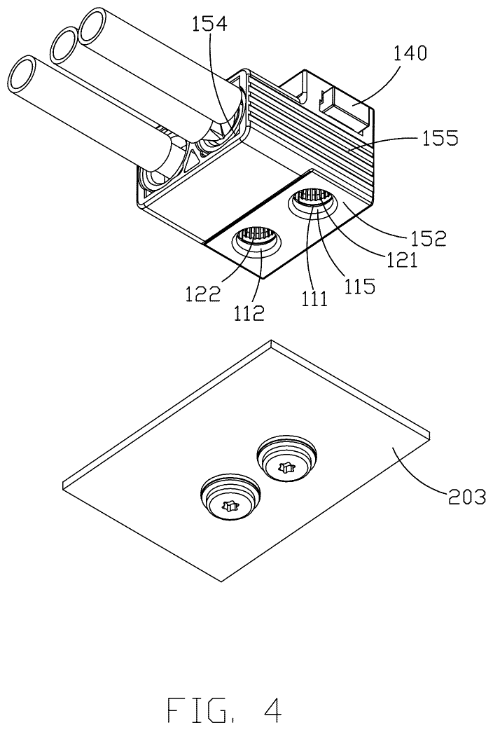

Referring to FIGS. 3-4, the housing 110 includes a top portion 151, a bottom portion 152, a front portion 153, a rear portion 154, a first side wall 155, and a second side wall 156. The first side wall 155 and the second side wall 156 are each disposed between the top portion 151, the bottom portion 152, the front portion 153, and the rear portion 154. The housing 110 includes a first cavity 111 and a second cavity 112 for accommodating the first terminal 121 and the second terminal 122, respectively, and a latch accommodating channel 113 accessible to the first cavity 111 and the second cavity 112. The first cavity 111 and the second cavity 112 extend along a second direction perpendicular to the first direction and are separated by a partition wall 114 disposed in the housing 110. The bottom 152 is provided with a pair of bottom openings 115 in fluid communication with the first cavity 111 and the second cavity 112 respectively. The first mating terminal 211 and the second mating terminal 212 can respectively enter the first cavity 111 and the second cavity 112 through the pair of bottom openings 115 to be electrically connected with the corresponding terminals. The top portion 151 is provided with a pair of top openings 116. The first cavity 111 and the second cavity 112 are each communicated with the latch accommodating channel 113 and communicate respectively with the top openings 116. The rear portion 154 is provided with a pair of rear openings 117 in communication with the first cavity 111 and the second cavity 112 and through which the cable 130 can extend out.

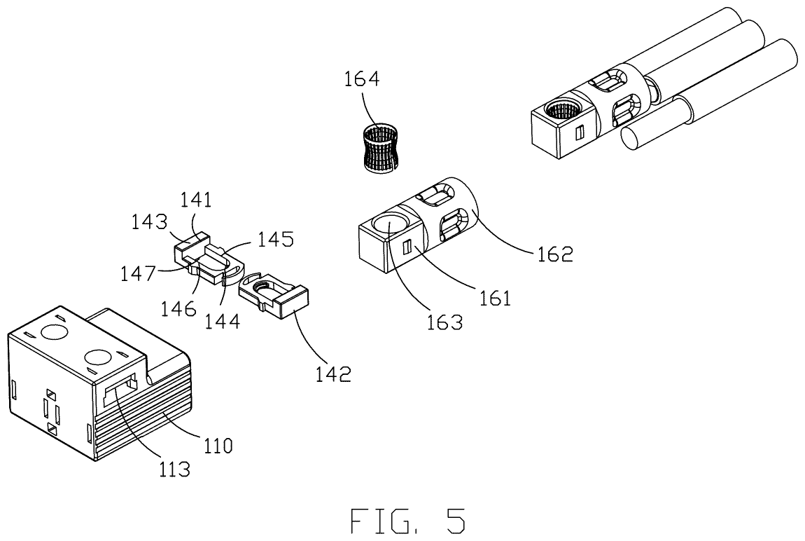

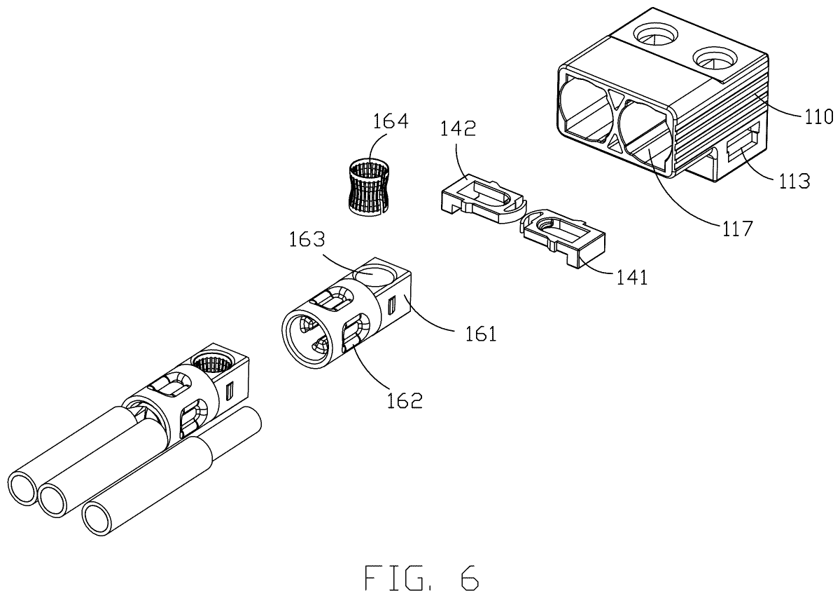

Referring to FIGS. 5-6, the first terminal 121 and the second terminal 122 each include a mating end 161 connected to the first mating terminal 211 and the second mating terminal 212, and a connecting end 162 connected to the cable 130. The mating end 161 includes a hole 163, and a crown spring terminal 164 disposed in the hole 163. The first mating terminal 201 and the second mating terminal 202 respectively enter the corresponding hole 163 and connect to the crown spring terminal 164.

Referring to FIGS. 5-9, the latch accommodating channel 113 is recessed inward from the first side wall 155 and the second side wall 156 along a third direction perpendicular to the first direction and the second direction. The latch 140 includes a first latch 141 and a second latch 142 respectively engaging the first mating terminal 211 and the second mating terminal 212. In other embodiments, the latch accommodating channel 113 may be arranged along any other direction or position, and a single latch may lock two or more mating terminals simultaneously, or a plurality of latches may be provided, each latch corresponding to a mating terminal. The first latch 141 and the second latch 142 are movably and oppositely disposed in the latch accommodating channel 113. The first latch 141 and the second latch 142 each include a release portion 143 exposed by the housing 110, a first arm 144 opposite to the release portion 143, and a second arm 145 and a third arm 146 connecting the release portion 143 and the first arm 144. The release portion 143, the first arm 144, the second arm 145, and the third arm 146 form an enclosing space 147 that can surround the corresponding mating terminal. Specifically, the mating terminal passes through the enclosing space 147. In this embodiment, the release portion 143, the first arm 144, the second arm 145 and the third arm 146 form a substantially rectangular surrounding space 147. In other various embodiments, the surrounding space may also be of other shapes. At least one of the first arm 144, the second arm 145 and the third arm 146 is provided with a first protrusion 148 protruding into the enclosing space 147 and capable of engaging the groove 207 of the mating terminal to lock it. The shape and size of the first protrusion 148 are configured to be suitable for engaging the groove 207. In this embodiment, only a first protrusion 148 is provided on the first arm 144. In other embodiments, the first protrusion 148 can be disposed on other second arms and third arms, and the number of the first protrusions 148 can be designed according to the needs. For example, one protrusion may be provided on one of the arms, or protrusions may be provided on two of the arms, or protrusions may be provided on all three arms at the same time. It can be set based on the strength required to engage the mating terminal. The first latch 141 and the second latch 142 are both provided with a limiting portion 170 that cooperates with the housing 110 to limit the position of the latch. The limiting portion 170 includes a second protrusion 171 disposed on the outer side of the second arm 145 and a third protrusion 172 disposed on the outer side of the third arm 146. The housing 110 is provided with a first limiting recess 181 for limiting the second protrusion 171 and a second limiting recess 182 for limiting the third protrusion 172 at corresponding positions. The first limiting recess 181 and the second limiting recess 182 each include an inclined surface 183 and a stop surface 184. The second protrusion 171 and the third protrusion 172 are limited between the stop surface 184 and the inclined surface 183 in the locked and unlocked states, so that the first latch 141 and the second latch 142 are always kept in the housing 110.

An elastic member 190 is disposed in the latch accommodating channel 113, and the elastic member 190 can provide a moving space for the latch between the locked position and the unlocked position and keep the latch in the locked position. The elastic member 190 may be formed integrally with the latch, or integrally formed with the housing, or may be a separate elastic member disposed between the latch and the housing. In this embodiment, the elastic member 190 is formed integrally with the latch 140. The elastic member 190 includes a first elastic arm 191 extending outward from an outer side of the first arm 144 of the first latch 141 and a second elastic arm 192 extending outward from an outer side of the first arm 144 of the second latch 142. The housing 110 includes a partition wall 118. The partition wall 118 divides the latch accommodating channel 113 into a first accommodating channel 113a for accommodating the first latch 141 and a second accommodating channel 113b for accommodating the second latch 142. Specifically, when the first elastic arm 191 and the second elastic arm 192 are in the extended state, the first protrusions 148 of the first latch 141 and the second latch 142 respectively engage the grooves 207 of the corresponding mating terminals, the second protrusion 171 and the third protrusion 172 are respectively stopped at the corresponding stop surfaces 184, and the first latch 141 and the second latch 142 are both kept at the locked position. When the release portions 143 of the first latch 141 and the second latch 142 are pressed simultaneously, and the first elastic arm 191 and the second elastic arm 192 are further compressed to the partition wall 118, the first latch 141 and the second latch 142 move inward, the second protrusion 171 and the third protrusion 172 move away from the stop surface 184 toward the inclined surface 183, the first protrusions 148 are released from corresponding groove 207, the cable-end connector 100 can be removed from the board-end connector 200 without any obstruction.

In other embodiments, the latch accommodating channel 113 may be a through channel for receiving both the first latch 141 and the second latch 142. That is, there is no partition wall between the first latch 141 and the second latch 142. When the first elastic arm 191 and the second elastic arm 192 are in the extended state, the first latch 141 and the second latch 142 are both kept in the locked position. When unlocking, the release portions 143 of the first latch 141 and the second latch 142 are pressed simultaneously, the first elastic arm 191 and the second elastic arm 192 are forced to abut against each other and are further compressed, so that the first latch 141 and the second latch 142 move from the locked position to the unlocked position.

The cable-end connector in the present invention realizes a more reliable and stable connection with the board-end connector through the design of the latch structure, thereby ensuring the safety and stability of power transmission.

1. An electrical connector comprising:
a cable extending along a first direction;
a terminal connected to the cable;
a housing comprising:
a top portion, a bottom portion, and a first side wall and a second side wall between the top portion and the bottom portion;
a cavity receiving the terminal and extending along a second direction perpendicular to the first direction, the cavity being in fluid communication with an opening of the bottom portion for entry of a mating terminal; and
a latch accommodating channel in communication with the cavity; and
a latch movably received in the latch accommodating channel and configured to engage the mating terminal in a locked position and to release the mating terminal in an unlocked position; wherein
the latch comprises a release portion exposed by the housing, a first arm opposite to the release portion, and a second arm and a third arm connecting the release portion and the first arm, the release portion, the first arm, the second arm, and the third arm form an enclosing space surrounding the mating terminal, and at least one of the first arm, the second arm, and the third arm has a first protrusion protruding into the enclosing space to lock the mating terminal.

2. The electrical connector as claimed in claim 1, further comprising an elastic member urging the latch toward the locked position.

3. The electrical connector as claimed in claim 2, wherein the elastic member is integrally formed with the housing.

4. The electrical connector as claimed in claim 2, wherein the elastic member is an elastic arm formed integrally with the latch.

5. The electrical connector as claimed in claim 4, wherein the elastic arm extends outward from the outer side of the first arm.

6. The electrical connector as claimed in claim 2, wherein the second arm and the third arm are respectively provided with a limiting portion cooperating with the housing to limit the position of the latch.

7. The electrical connector as claimed in claim 6, wherein the limiting portion comprises a second protrusion arranged on the outside of the second arm and a third protrusion arranged on the outside of the third arm, and the latch accommodating channel is provided with a first limiting recess for limiting the second protrusion and a second limiting recess for limiting the third protrusion at corresponding positions.

8. The electrical connector as claimed in claim 7, wherein the first limiting recess and the second limiting recess each comprise an inclined surface and a stop surface, in the locked position, the elastic member is in an extended state, the first protrusion engages the mating terminal, and the second protrusion and the third protrusion stop at the corresponding stop surfaces, when the latch moves from the locked position to the unlocked position, the latch release portion is pressed, the elastic arm is further compressed, the first protrusion releases the mating terminal, and the second protrusion and the third protrusion respectively move toward the corresponding inclined surfaces and stop at the inclined surfaces.

9. The electrical connector as claimed in claim 1, wherein the latch accommodating channel is recessed inwardly from the first side wall or the second side wall along a third direction perpendicular to the first direction and the second direction.

10. An electrical connector comprising:
a cable extending along a first direction;
a first terminal and a second terminal connected to the cable;
a housing comprising:
a top portion, a bottom portion, and a first side wall and a second side wall between the top portion and the bottom portion;
a first cavity and a second cavity respectively accommodating the first terminal and the second terminal and extending along a second direction perpendicular to the first direction, the bottom portion comprising a pair of openings in fluid communication with the first cavity and the second cavity for a pair of mating terminals to enter the first cavity and the second cavity through the pair of the openings to be electrically connected to the first contact terminal and the second contact terminal; and
a latch accommodating channel in communication with the first cavity and the second cavity; and
a latch movably received in the latch accommodating channel and configured to engage the mating terminals in a locked position and to release the mating terminals in an unlocked position; wherein
the latch comprises a first latch engaging one of the pair of mating terminals and a second latch engaging the other of the pair of mating terminals, each of the first latch and the second latch comprises a release portion exposed by the housing, a first arm opposite to the release portion, and a second arm and a third arm connecting the release portion and the first arm, the release portion, the first arm, the second arm, and the third arm form an enclosing space surrounding the mating terminal, and at least one of the first arm, the second arm, and the third arm is provided with a first protrusion protruding into the enclosing space to lock the mating terminal.

11. The electrical connector as claimed in claim 10, wherein the latch accommodating channel penetrates the first side wall and the second side wall along a third direction perpendicular to the first direction and the second direction.

12. The electrical connector as claimed in claim 11, wherein the first latch and the second latch are respectively disposed opposite to each other from the first side wall and the second side wall and accommodated in the latch accommodating channel.

13. The electrical connector as claimed in claim 12, wherein the first latch comprises a first elastic arm, and the first elastic arm extends outward from the first arm of the first latch, the second latch comprises a second elastic arm, and the second elastic arm extends outward from the first arm of the second latch, the first elastic arm and the second elastic arm respectively provide movement space for the first latch and the second latch between the locked position and the unlocked position, and respectively push against the first latch and the second latch toward the locked position.

14. The electrical connector as claimed in claim 13, wherein the first protrusions of the first latch and the second latch are both arranged on the inner sides of the first arms thereof, when the first elastic arm and the second elastic arm are in an extended state, the first protrusions of the first latch and the second latch engage with the corresponding mating terminals, when the releasing parts of the first latch and the second latch are actuated, the first elastic arm and the second elastic arm are compressed by force, and the first protrusions of the first latch and the second latch release the corresponding mating terminals.

15. The electrical connector as claimed in claim 14, wherein the first elastic arm and the second elastic arm keep the first latch and the second latch in the locked position in the extended state, when the first elastic arm and the second elastic arm are forced to abut against each other and are further compressed, the first latch and the second latch move from the locked position to the unlocked position.

16. The electrical connector as claimed in claim 14, wherein the housing comprises a partition wall, and the latch accommodating channel is divided by the partition wall into a first accommodating channel accommodating the first latch and a second accommodating channel accommodating the second latch, when the first elastic arm and the second elastic arm are further compressed on the partition wall, the first latch and the second latch move from the locked position to the unlocked position.

17. The electrical connector as claimed in claim 16, wherein the second arm and the third arm of the first latch and the second latch are both provided with limiting portions respectively cooperating with the first latch accommodating channel and the second latch accommodating channel.

18. An electrical connector assembly comprising:
a board-end connector comprising a first mating terminal, a second mating terminal, and a substrate holding the first mating terminal and the second mating terminal; and
a cable-end connector for mating with the board-end connector, comprising:
a cable extending along a first direction;
a first terminal and a second terminal connected to the cable;
a housing comprising:
a top portion, a bottom portion, and a first side wall and a second side wall between the top portion and the bottom portion;
a first cavity and a second cavity respectively accommodating the first terminal and the second terminal and extending along a second direction perpendicular to the first direction, the bottom portion comprising a pair of openings in fluid communication with the first cavity and the second cavity, the first mating terminal and the second mating terminal respectively entering the first cavity and the second cavity through the pair of the openings to be electrically connected to the first contact terminal and the second contact terminal; and
a latch accommodating channel in communication with the first cavity and the second cavity; and
a latch movably received in the latch accommodating channel and configured to engage the first mating terminal and the second mating terminal in a locked position to lock the cable-end connector with the board-end connector, and to release the first mating terminal and the second mating terminal in an unlocked position to unlock the cable-end connector from the board-end connector; wherein the latch comprises a first latch engaging the first mating terminal and a second latch engaging the second mating terminal, each of the first latch and the second latch comprises a release portion exposed by the housing, a first arm opposite to the release portion, and a second arm and a third arm connecting the release portion and the first arm, the release portion, the first arm, the second arm, and the third arm form an enclosing space surrounding the mating terminal, and at least one of the first arm, the second arm, and the third arm is provided with a first protrusion protruding into the enclosing space to lock the mating terminal.

19. The electrical connector assembly as claimed in claim 18, wherein the release portion of the first latch is exposed at one of the first side wall and the second side wall, and the release portion of the second latch is exposed at the other of the first side wall and the second side wall.

20. The electrical connector assembly as claimed in claim 19, wherein the cable-end connector comprise a first elastic member cooperating with the first latch, and a second elastic member cooperating with the second latch, the first elastic member and the second elastic member can respectively provide the first latch and the second latch with movement space between the locked position and the unlocked position, and respectively push against the first latch and the second latch toward the locked position.
